(19) United States
(12) Patent Application Publication
(10) Pub. No.: US 2019/0099780 A1
(43) Pub. Date: Apr. 4, 2019

(54) METHOD FOR PRODUCING A HEAT-STABLE COATING BY DIGITAL PRINTING

(71) Applicant: SEB S.A., ECULLY (FR)

(72) Inventors: Laurent CAILLIER, PRINGY (FR); Stéphanie LE BRIS, CHAMBERY (FR); Sylvain DAGAND, CUSY (FR)

(21) Appl. No.: 16/083,266

(22) PCT Filed: Mar. 10, 2017
(86) PCT No.: PCT/FR2017/050551

§ 371 Date: Sep. 7, 2018

(30) Foreign Application Priority Data
Mar. 10, 2016 (FR) 1652025

(51) Int. Cl. B05D 1/26; B41J 2/14; B41J 2/16; B41M 5/00; B05D 7/00; A47J 27/00

(52) U.S. Cl. CPC B05D 1/26; B41J 2/14; B41J 2/1606; B41M 5/0047; B05D 7/50; A47J 27/002; B05D 7/26; B05D 2202/00; B05D 2430/00; B05D 2506/10; B05D 2601/22; B05D 2601/24; B05D 2203/35

(57) ABSTRACT

A method for producing a small heating household appliance article having a substrate with at least two opposite faces, includes providing the substrate and obtaining a heat-stable coating on the substrate. The procedure for obtaining a coating includes depositing by digital printing, on at least one of the two opposite faces of the substrate and through at least one nozzle having an aperture of at least 80 μm, at least one layer of a composition including at least one binder and having a dry extract of at least 15% by weight, and curing the coated substrate.

This invention concerns in general a method for producing a small heating household equipment article, and in particular a method for producing a small heating household equipment article comprising a heat-stable coating obtained by digital printing.

Within the meaning of this invention, heating article means an article whose temperature will increase during its use. Such an article may be either an article that has its own heating system or an article that is heated by an outside heating system. In addition, such an article is able to transmit the heat energy provided by the heating system to another material or object in contact with said article.

Within the meaning of this invention, small heating household equipment article means culinary articles and small household appliance articles.

Persons skilled in the art know of several types of techniques for obtaining heat-stable coatings on small household equipment articles.

In particular, it is known to use screen printing, spraying, roller application, pad printing or curtain coating techniques to apply these coatings to flat surfaces. However, each of these techniques has disadvantages that may necessitate the development of new methodologies.

Thus, spraying, curtain coating and roller application are non-localized techniques. It will not be possible to deposit the coating in a precise and controlled manner. In addition, spraying has the disadvantage of generating much loss of material through the classic phenomenon of overspray (i.e., the entire portion of the spray cone does not reach the part to be coated) which generates costs (overconsumption, sludge recycling, etc.). In addition, spraying does not permit achieving perfect homogeneity in terms of thickness when considering the entire covered surface. The same is true for the curtain technique, which is completely inappropriate for a controlled deposition and results in much overconsumption of material.

Roller application, screen printing and pad printing are contact techniques. They therefore require dryings between each deposition step. In addition, the point of contact of the roller or the screen may produce a hatched appearance in the final coating, the hatching possibly generating low-quality appearance defects. Printing localized depositions using this type of technology necessitates the use of specific printing forms (rollers, screens, printing plates), resulting in a need for consumables and burdensome production changeovers.

Ink jet technology seems able to respond to the preceding limitations and in particular has been described in the patent document WO2012/085477, which concerns a process for manufacturing a heating article comprising a step of applying at least one two-color decoration in the form of a continuous or discontinuous layer by printing using the ink jet process.

However, the processes and compositions described in that document have the major disadvantage that in order to obtain a coating thick enough for the envisioned uses of the article, a significant number of layers must be deposited, greatly increasing the number of printing passes, and numerous dryings must be carried out in order to obtain a homogeneous deposition and avoid edge effects.

To correct the disadvantages of the prior art, the applicant has developed a process of producing small heating household equipment articles comprising a heat-stable coating that can be implemented under industrial conditions.

The purpose of this invention is therefore a process for producing a small heating household equipment article comprising a substrate with at least two opposite faces, the process comprising:
providing said substrate; and
obtaining a heat-stable coating on said substrate, said obtaining step comprising:
   depositing on at least one of the two opposite faces of said substrate at least one layer of a composition comprising at least one binder; and
   curing said coated substrate,

characterized in that the composition comprising at least one binder has a dry matter content greater than or equal to 15% by weight, and

in that said deposition is carried out through digital printing via at least one nozzle having an aperture greater than or equal to 80 μm in size.

Advantageously, said composition comprising at least one binder has a dry matter content greater than or equal to 20% by weight, preferably strictly greater than 20%. It should be noted that the composition may be in different forms such as a fluid, a liquid, a semi-liquid or a more or less viscous paste.

It has in fact been determined that, to make a coating thick enough for the envisioned applications of the article, the use of concentrated compositions has the advantage of significantly decreasing the number of layers and thus the number of printing passes, as well as the number of dryings, and permitting good homogeneity of the layers.

In addition, in order to obtain a functional coating, a large nozzle aperture size allows the passage of large fillers.

Preferably, said composition comprising at least one binder has a dry matter content less than or equal to 100% by weight, preferably between 22% and 100%, more preferably between 25% and 90%, even more preferably between 30% and 70%, percentage by weight.

Obtaining the heat-stable coating on at least one of the faces of the substrate includes digital printing of a composition comprising at least one binder.

Within the meaning of the invention, printing means the deposition of a composition comprising at least one binder on a substrate, to obtain a continuous or discontinuous layer. Prior to deposition, the composition comprising at least one binder is the printing composition. After deposition, the composition comprising at least one binder deposited on the substrate is the printed composition.

Within the meaning of this invention, digital printing means printing done directly on the substrate using computer data (or digital files) in a continuous flow between a computer and the printing machine.

Advantageously, the composition is printed on the substrate without using a printing form.

Advantageously, the digital printing of the heat-stable coating according to this invention is carried out through an ink jet process, using ink jet printers.

Advantageously, the deposition of the process according to the invention is carried out through digital printing using the ink jet process.

The ink jet process is a printing technique that consists of propelling droplets of ink or fluid from the aperture of a nozzle onto clearly identified positions on a substrate. The ink jet process is the only non-contact printing process, meaning that the ink or the printing composition is deposited on the substrate without using a means for depositing it, such as printing forms (rollers, screens, printing plates). The ejection of droplets is controlled electronically by high-frequency digital signals. The formation of droplets relies in part on control of the pressure of the liquid ink in its reservoir and in the printing nozzles when the ink flow is broken or divided into droplets, or on the opening of high-frequency microvalves thus releasing droplets. Just before its deposition on the substrate and just after its ejection from the nozzle, the ink or the printing composition is in contact only with ambient air and is not in contact with any means. There are several ink jet technologies and they are based on different solutions for controlling the pressure of the liquid ink or opening the microvalves, and thus on different printhead configurations.

The two main ink jet process technology families are the continuous ink jet technique and the Drop-on-Demand technique.

The continuous ink jet technique (CIJ) is based on controlled fragmentation of a liquid jet. Disturbances cause the jet to break into droplets of a controlled size, at a well-defined speed. This is achieved by synchronization between the breaking of the jet and its speed. The printing composition droplets which reach the print substrate are selected electrostatically, for example (charging of drops, then deflection of these drops by an electric field). The printheads in this technique are characterized by the continuous generation of printing composition drops, the drops being deflected, via a deflector, according to the pattern to be generated, toward a collector to print the desired pattern.

The Drop-on-Demand technique (DOD) relies on a different physical process: the ink is held in the reservoir, forming a meniscus at the nozzle, until a pressure applied to the volume of liquid exceeds the surface tension, and permits a droplet to be ejected.

The printheads in this technique are characterized by on-demand generation of printing composition drops, according to the pattern to be printed. Four different ejection methods, among others, may be considered: piezoelectric, thermal or bubble jet, valve jet, and thermofusion.

Advantageously, the deposition of the process according to the invention is carried out through digital printing using the Drop-on-Demand ink jet process.

In the printheads of the piezoelectric technique, the delivery channels for the printing compositions are surrounded by piezoelectric membranes, which deform under the effect of electrical excitation, thus deforming the delivery channels and causing the expulsion of the printing composition.

In another type of piezoelectric DOD printhead, as described in U.S. Pat. No. 6,460,980, ejection is caused by vibration of the ink delivery channel followed by an excitation of a piezoelectric crystal welded on this channel. In the printheads of the valve-jet technique, the ejection of fluid is controlled by microvalves.

Thus, the patent application WO2013/013983 describes printheads equipped with solenoid valves which open and close under the effect of electrical excitation.

The patent application WO2016/030566 describes valves controlled by a piezoelectric material.

For its part, the patent application WO2010/146473 describes a device composed of a piezoelectric system coupled to a membrane which permits controlling the ejection of fluid drops.

Within the meaning of the invention, nozzle refers to a means permitting the flow and discharge of the printing composition or output. It may also be a pipe or equivalent. It may be a tip or equivalent permitting discharge by spraying. It may also be a capillary tube or equivalent. It may also be a delivery channel or equivalent. It is understood that a nozzle can be called interchangeably a jet nozzle, a print nozzle, an outlet nozzle or a spray nozzle. A nozzle may be part of a set of means forming a printhead or it may be the printhead. Generally, a printhead comprises 10 to 5,000 nozzles.

In particular, nozzles may be equipped with means to permit breaking the printing composition into droplets. These may be means that reduce the cross section of the nozzle, such as a nozzle plate, for example. Generally, a droplet has a volume of between 10 and 10,000 picoliters.

Advantageously, the droplets form a directional jet, generally oriented perpendicularly with respect to the cross section of the nozzle.

Advantageously, a single directional jet is formed by the nozzle.

Within the meaning of the invention, directional jet means an alignment of droplets, a cloud of droplets or a single droplet.

The nozzle may be made of metallic material, such as stainless steel, of ceramic material, including material with piezoelectric properties, of polymer material or mixtures thereof, or of any conventional material for a nozzle.

The nozzle comprises an aperture.

Within the meaning of the invention, aperture means a hole, slot or opening permitting the discharge or release of the printing composition.

The nozzle aperture is preferably situated at one of the ends of the nozzle forming a liquid ejecting head. The aperture may be free, that is, in contact only with ambient air. The aperture may, according to the configurations, be either straight or beveled. The aperture may be made of the same material as the nozzle or be a related element of a different material or a material treated (chemical or physical treatment) to give it specific properties.

A nozzle may comprise one or more apertures.

According to certain variants, the nozzle and the aperture form a single means, in particular concerning a hole along a delivery pipe or concerning the end of this pipe.

The size of the nozzle aperture used in the process according to the invention makes it possible to adapt the deposition of the printing composition by varying the size of the aperture according to the physico-chemical properties of the printing composition, such as viscosity, surface tension, type, nature, particle size, density or dry matter content.

According to this invention, the size of the nozzle aperture is greater than or equal to 80 μm, preferably greater than or equal to 90 μm, more preferably greater than or equal to 100 μm.

Nozzle aperture size means the smallest opening dimension of the nozzle. For example, if the nozzle aperture has a circular cross section, in this case the smallest opening dimension is the diameter of this circle. If the nozzle aperture has an ovoid cross section, in this case the smallest opening dimension is the smallest diameter of this oval. If the nozzle aperture has a rectangular cross section, in this case the smallest opening dimension is the smallest side of this rectangle.

Advantageously, the size of the nozzle aperture is less than or equal to 1.5 mm, preferably less than or equal to 1 mm, and more preferably less than or equal to 800 μm.

Preferably, the size of the nozzle aperture is between 80 μm and 800 μm, preferably between 90 μm and 750 μm, more preferably between 95 μm and 700 μm, and even more preferably between 100 μm and 650 μm.

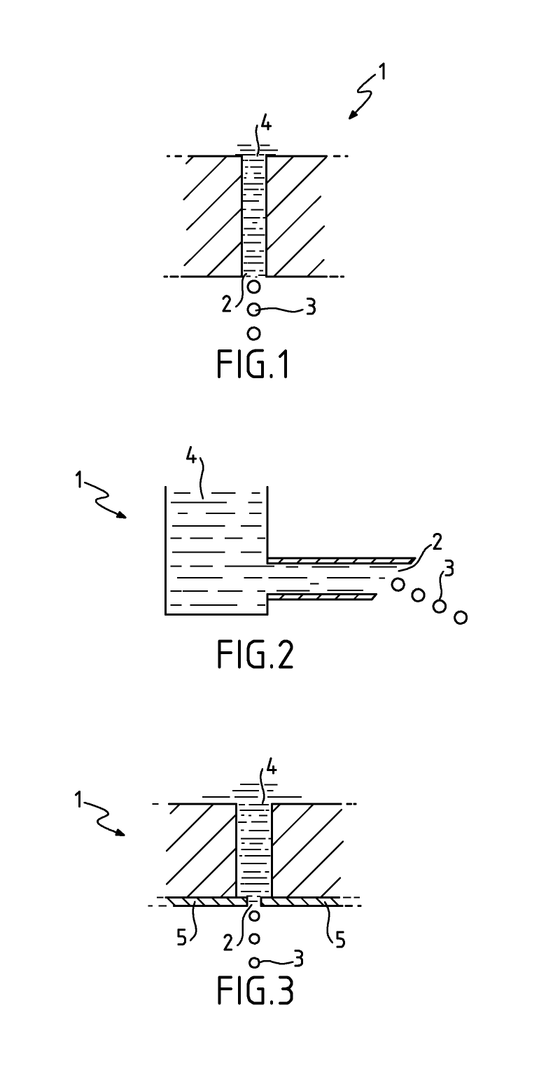

FIG. 1 illustrates a schematic profile view of a first embodiment of a nozzle suitable for implementation of the process according to the invention by digital printing. The nozzle 1 is equipped with an aperture 2 generating a directional jet of droplets of printing composition 3. The nozzle is equipped with a printing composition inlet or feed 4.

FIG. 2 illustrates a schematic profile view of a second embodiment of a nozzle suitable for implementation of the process according to the invention by digital printing. The nozzle 1 is equipped with a beveled aperture 2 generating a directional jet of droplets of printing composition 3. The nozzle is equipped with a printing composition inlet or feed 4.

FIG. 3 illustrates a schematic profile view of a third embodiment of a nozzle suitable for implementation of the process according to the invention by digital printing, which is a variant of FIG. 1 in which the nozzle hole is reduced by a nozzle plate 5 forming a smaller aperture 2. The nozzle 1 is equipped with an aperture 2 that is smaller compared to that of FIG. 1 generating a directional jet of droplets of printing composition 3. The nozzle is equipped with a printing composition inlet or feed 4. The material of the nozzle plate 5 may be identical to or different from that of the nozzle 1, such as stainless steel. The nozzle plate 5 may, according to the variants, be chemically or physically treated or covered with a coating to give it specific properties, in particular so that the droplet 3 is formed correctly and ejected properly without wetting the nozzle plate.

Advantageously, the nozzle surface in contact with the printing composition may be chemically or physically treated or covered with a coating to give it specific properties. In particular, it is advantageous that the end of the nozzle facilitates the formation of the droplet and facilitates its ejection by preventing the wetting of the end of the nozzle.

The printing composition is deposited via the nozzle, which means that the nozzle is double ended and the composition flows in the nozzle hole.

The process according to the invention may use one or more nozzles, which may be similar or different according to the printing needs, comprising one or more apertures of similar or different sizes.

Within the meaning of this invention, a heat-stable coating is a coating resistant to at least 200° C.

The binder of the printing composition for digital printing comprises at least one of a bonding resin, a fluorocarbon resin, a sol-gel composition, an enamel frit slip, a lacquer, a condensed tannin.

Advantageously, said binder may comprise a fluorocarbon resin and at least one bonding resin and/or at least one condensed tannin.

The fluorocarbon resin may be chosen from the group comprising polytetrafluoroethylene (PTFE), tetrafluoroethylene and perfluoromethylvinylether copolymers (such as MFA), tetrafluoroethylene and perfluoropropyl vinyl ethercopolymers (such as PFA), tetrafluoroethylene and hexafluoropropylene copolymers (such as FEP) and mixtures thereof.

The bonding resin may be chosen from the group comprising polyetherketones (PEK), polyetheretherketones (PEEK), polyimide-imides (PAI), polyetherim ides (PEI), polyim ides (PI), polyethersulfones (PES), polyphenylene sulfides (PPS).

The condensed tannin may have as base unit one or more flavan-3-ol and/or flavan-3,4-diol monomer unit(s) and/or phlorotannins.

Advantageously, said binder may comprise a condensed tannin, preferably having as base unit one or more flavan-3-ol and/or flavan-3,4-diol monomer units and/or phlorotannins.

Advantageously, said binder may comprise a sol-gel composition obtained by hydrolysis of a metal alkoxide sol-gel precursor, by introduction of water and of an acid or basic catalyst, and then by condensation.

The metal alkoxide sol-gel precursor may be chosen from the group comprising the following compounds:
precursors following the general formula M₁(OR₁)n,
precursors following the general formula M₂(OR₂)₍ₙ₋₁₎R₂′, and
precursors following the general formula M₃(OR₃)₍ₙ₋₂₎(R₃′)₂, where:
   R₁, R₂, R₃ or R₃′ designates an alkyl group,
   R₂′ designates a possibly functionalized alkyl group or a possibly functionalized phenyl group,
   n is a whole number corresponding to the maximum valence of M₁, M₂ or M₃,

M₁, M₂ or M₃ designates an element chosen from Si, Zr, Ti, Sn, Al, Ce, V, Nb, Hf, Mg or the lanthanides (Ln).

Preferably, the metal alkoxide sol-gel precursor is an alkoxysilane, which may be chosen from the group comprising methyltrimethoxysilane (MTMS), methyltriethoxysilane (MTES), tetraethoxysilane (TEOS), tetramethoxysilane (TMOS), and 3-glycidoxypropyltrimethoxysilane (GLYMO), am inopropyl-triethoxysilane (APTES) and mixtures thereof.

Advantageously, said binder may comprise an aqueous enamel frit slip which may contain mostly silicon oxide and titanium oxide, mixed with fluxes chosen from iron oxides, vanadium oxides, boron oxides, sodium oxides, potassium oxides.

Advantageously, said binder may comprise a lacquer which may be chosen from silicon, polyester or silicon-polyester lacquers.

The printing composition for digital printing may advantageously further comprise functional fillers. Within the meaning of this invention, functional fillers means fillers that are found in their initial form at the end of the article manufacturing process.

Advantageously, the average size of the functional fillers may be greater than or equal to 10 nm and less than or equal to 300 μm, and preferably greater than or equal to 10 nm and less than or equal to 100 μm.

Such functional fillers may be pigments, anisotropic particles (or flakes), reinforcing fillers, fillers promoting adhesion (such as colloidal silica, for example), antibacterial fillers (such as a silver dispersion, for example).

The reinforcing fillers that can be used in the context of this invention include in particular micronic or sub-micronic fillers, in powder or dispersion form, comprising at least one of the following: SiO₂, Al₂O₃, TiO₂, SiC, diamond, boron nitride, rare earth oxides, such as CeO₂, talc, kaolin, baryte, wollastonite, PTFE powder and mixtures thereof.

The pigments that can be used in the context of this invention include in particular heat-stable organic or inorganic pigments, metallic salts, semiconducting thermochromic pigments and mixtures thereof. The pigments may be independently chosen from titanium dioxide, spinels, iron oxides, perylene red, dioxazine violet, mixed aluminum and cobalt oxides (such as cobalt alum inate (CoAl₂O₄)), carbon black, chromium oxides and copper oxides, chromium titanate, antimony, nickel titanate, silico-aluminates, inorganic pigments with spinel crystalline structure based on various metal oxides, semiconducting thermochromic pigments (for example, semiconducting metallic oxides such as Fe₂O₃, Bi₂O₃, or BiVO₄) and mixtures thereof.

The anisotropic particles that can be used in the context of this invention are particles whose characteristic dimensions are not identical in all directions, such as, for example, fibers (essentially one-dimensional in form) or flakes (essentially two-dimensional or flat in form). The flakes that can be used in the context of this invention may be independently chosen from coated or uncoated mica flakes, coated or uncoated silica flakes, coated (in iron oxide in particular) or uncoated aluminum flakes, coated or uncoated iron oxide flakes, mica or silica flakes coated with titanium dioxide or iron oxide. The flakes that can be used in the context of this invention may be treated to achieve a particular color effect.

The anisotropic particles that can be used in the context of this invention may, for example, be magnetizable or electrifiable. In the context of this invention, the magnetizable particles may advantageously be particles comprising at least one ferromagnetic metal. These magnetizable particles may be homogeneous in nature, that is, consisting of the same material, or composite in nature, that is, magnetizable particles with a core-shell structure in which the ferromagnetic metal is found in the core and/or in the shell of said particles. Examples of composite magnetizable particles include mica flakes coated with iron oxide Fe₂O₃ or stainless steel fibers coated with a sol-gel material, as a protection against corrosion during steps of implementation of the coating, or flakes of plastic material coated with iron oxide Fe₂O₃, or flakes with a core of ferromagnetic metal and a shell formed of a plastic material or a sol-gel material.

The application of the heat-stable coating by printing using the ink jet process may be done on the flat substrate or on the shaped substrate or on a locally flat area of the shaped substrate. A layer of heat-stable coating is obtained. Generally, this layer of heat-stable coating is wet.

Within the meaning of this invention, wet layer means the layer formed by the droplets once deposited on the substrate; generally, the wet layer comprises all or a portion of its solvents. The wet layer is also called the wet printed layer. The wet layer is generally obtained just after printing of the heat-stable coating layer comprising the composition comprising at least one binder.

Advantageously, the thickness of the layer printed by digital printing is greater than 0.1 μm and less than or equal to 1000 μm, and preferably greater than or equal to 1 μm and less than or equal to 200 μm.

Preferably, all or a portion of the solvents in the wet layer are eliminated, either naturally or by a physical treatment, for example by thermal drying, air flow drying or vacuum treatment.

According to a variant of the process according to this invention, the application of the heat-stable coating by printing using the ink jet process may be done in several layers. In this case, the deposition on at least one of the two opposite faces of said substrate of at least one layer of a composition comprising at least one binder is repeated several times. In this case, the heat-stable coating is multilayer. Each layer is preferably made in a single printing step, the whole forming a multilayer. Preferably according to this variant, a drying step takes place between the application of each layer, and then said coated substrate is cured after application of the last layer.

Within the meaning of this invention, curing of the coated substrate means a thermal treatment to thicken the layer or layers of heat-stable coating applied on the substrate, this thermal thickening treatment being performed
at a temperature greater than 150° C. when said layers are obtained from compositions whose binder comprises a sol-gel and/or a lacquer,
at a temperature greater than 200° C. when said layers are obtained from compositions whose binder comprises a condensed tannin,
at a temperature greater than 300° C. when said layers are obtained from compositions whose binder comprises a fluorocarbon resin, and
at a temperature greater than 500° C. when said layers are obtained from compositions whose binder comprises an aqueous enamel frit slip.

The process according to this invention may further comprise a step of treatment of the substrate surface prior to the step of obtaining the heat-stable coating.

Advantageously, the face of the substrate on which the heat-stable coating will be applied may be treated so as to increase its specific surface area; for an aluminum substrate, this treatment may be performed by anodization (creation of a tubular alumina structure), by chemical attack, sanding, brushing, shot blasting or addition of material using a technology such as thermal spraying (flame, plasma or arc spray). The other metallic substrates may also be polished, sanded, brushed, microbead blasted or receive an addition of material using a technology such as thermal spraying (flame, plasma or arc spray).

The heat-stable coating deposited by the process of this invention may possibly further comprise at least one decoration and/or at least one other layer, such as an undercoat, a primer layer or a protective layer. In this case, the process according to the invention further comprises the deposition of one or more other layers and/or decorations. These layers may be applied by digital printing according to the process of this invention or by any other appropriate technique known to those skilled in the art, such as, for example, spraying, curtain coating, roller application, pad printing, screen printing, etc. These decorations may be applied by digital printing or by any other appropriate technique known to those skilled in the art, such as, for example, spraying, curtain coating, roller application, pad printing, screen printing, etc.

According to one aspect of the invention, after curing of the coated substrate, the thickness of the heat-stable coating is greater than 0.1 μm and less than or equal to 1000 μm, and preferably greater than or equal to 1 μm and less than or equal to 200 μm.

Different types of small heating household equipment articles conforming to this invention could be envisioned, in different forms and made of different materials.

Thus, according to the necessary conditions of use and thermal treatment, the substrate may be chosen from among metallic material substrates, glass substrates, ceramic substrates, terracotta substrates, plastic substrates.

Metallic substrates that can be used in this invention advantageously include anodized or non-anodized aluminum substrates, which may be polished, brushed, sanded, shot blasted or microbead blasted; anodized or non-anodized aluminum alloy substrates, which may be polished, brushed, sanded or microbead blasted; steel substrates which may be polished, brushed, sanded, shot blasted or microbead blasted; stainless steel substrates which may be polished, brushed, sanded or microbead blasted; cast steel, cast aluminum or cast iron substrates; copper substrates which may be hammered or polished.

Advantageously, the substrate may be chosen from among the substrates comprising ferritic stainless steel/aluminum/austenitic stainless steel layers, substrates comprising stainless steel/aluminum/copper/alum inum/austenitic stainless steel layers, cast aluminum, aluminum or aluminum alloy caps lined with a stainless steel outer bottom, roll-bonded metallic substrates, for example bilayer roll-bonded substrates comprising a stainless steel layer (for example, intended to constitute the inner face of the article) and a layer of anodized or non-anodized aluminum or aluminum alloy (for example, intended to constitute the outer face of the article).

The small heating household equipment article according to this invention may in particular be a culinary article or a small household appliance article such as an iron, a hair care article, an isothermal pot (for a coffee maker, for example) or a mixing vessel.

The small heating household equipment article according to this invention may in particular be a culinary article, and in particular a culinary article of which one of the two opposite faces of the substrate is an inner face, possibly concave, intended to be arranged on the side where food may be added to or on said article, and of which the other face of the substrate is an outer face, possibly convex, intended to be arranged toward a heat source.

Non-restrictive examples of culinary articles conforming to this invention include in particular culinary articles such as saucepans and frying pans, woks and skillets, Dutch ovens and kettles, crepe pans, waffle irons, gridirons, baking molds and sheets, planchas, grates and barbecue grills, raclette grills or fondue makers, rice cookers, jam makers, bread machine tubs, mixing bowls.

The small heating household equipment article according to this invention may in particular be an iron, such as a steam iron or a steam generator, and the substrate coated according to this invention is the ironing soleplate.

The small heating household equipment article according to this invention may in particular be a hair care article, such as a curling iron or straightening iron, and the substrate coated according to this invention is one of the heating plates of the hair care article.

The advantages of the process according to the invention are the following:
in terms of product performance: overall control of the homogeneity of the coating (in particular its thickness), control of the location of the deposition, absence of hatched appearance and possibility of simultaneously making low thickness depositions (about 1 micron—difficult to achieve using other traditional coating techniques) and high thickness depositions (several microns).
in terms of process:
   absence of or dramatic reduction in loss of material: adjustment of the ink quantity to printing needs, no overspray phenomenon or spraying spillover, easy to clean,
   absence of need for printing forms such as rollers, inking cylinders, screens, printing plates, plate cylinders, for example,
   reduction of need for inter-layer drying steps, non-contact deposition in effect permits deposition on a preceding layer that has not yet dried,
   possibility of immediate production changeover, in effect no need to install specific printing form, production changeover requires only the loading of a computer file
   possibility of very high rates,
   absence of contact with the printing machine,
   low labor requirements,
   printing is done continuously from the computer by print run, without interruption of the digital flow,
   the printing parameters may be changed with each article printed, without interrupting the process, thus making it possible to vary layer thicknesses or decorations;
in terms of safety and environment: the use of a fully closed fluid system, permitting the absence of contact between printer and operator and permitting traceability in production.

The invention is illustrated in more detail in the following examples.

### EXAMPLES

### Tests

### Determination of the Dry Matter Content of a Composition

### Principle

The dry matter content of a product is the residual solid part remaining after evaporation of the volatile materials it contains. The temperature and duration of drying play a major role, because high-boiling-point solvents, monomer fractions, reactive diluents and reaction by-products (according to their degree of retention) leave the film in formation very slowly. It is therefore very important to define standardized drying conditions in a very conventional manner, as close as possible to practice.

### Procedure

To measure this dry matter content, we proceed as follows:
weigh an aluminum cup: m₀=mass of the cup;
place in this cup between 0.5 g and 3 g of product to be studied;
weigh the filled cup: m₁=mass of the filled cup;
place the cup in a 210° C. oven for two hours;
after curing and after cooling, weigh the cup: m₂=mass of the filled cup after curing and cooking;
the dry matter content is given by the below formula:

Dry matter content=100*[(m₂−m₀)/(m₁−m₀)]

Examples 1 to 14 are examples according to the invention. Comparative examples 1 and 2 are not examples according to the invention.

### Example 1

### Substrate with Non-Stick Coatings and Decoration Based on Fluorocarbon Resin

The substrate is a chemically cleaned aluminum disk.

A coating based on fluorocarbon resin, bonding resin and mineral reinforcing fillers is applied by screen printing in successive layers on the first face of the disk.

The whole is precured at a temperature of 350° C.

The second face of the disk receives by screen printing an undercoat of white composition based on fluorocarbon resin.

A photo-realistic decoration is made by printing a decoration composition, based on colored particulate pigments and free of binder, by ink jet process using a printing system equipped with standard Drop-on-Demand printheads, type Xaar 1001, whose nozzles have an aperture of about 1 μm, at a resolution of 360 DPI on the white undercoat. The thickness of the wet decoration thus obtained is between 0.5 μm and 5 μm.

A colorless protective layer is made, on the decoration and the white undercoat, by printing a composition comprising a PTFE dispersion, solvents and conventional additives. Said composition has a dry matter content of about 50-55% by weight. This composition is deposited by means of a digital printing machine equipped with valve-jet technology printheads whose nozzles have an aperture of 100 μm. The thickness of the wet layer thus deposited is about 20 μm.

The disk coated on its two faces is cured at 430° C. for 10 minutes.

The thickness of the cured coating thus obtained on the second face of the disk is about 30 μm.

### Example 2

### Substrate with Non-Stick Coatings and Decoration Based on Fluorocarbon Resin

The substrate is a chemically cleaned aluminum disk.

A coating based on fluorocarbon resin, bonding resin and mineral reinforcing fillers is applied by screen printing in successive layers on the first face of the disk.

The whole is precured at a temperature of 350° C.

The second face of the disk receives by screen printing an undercoat of white composition based on fluorocarbon resin.

A photo-realistic decoration is made by printing a decoration composition, based on colored particulate pigments and free of binder, by ink jet process using a printing system equipped with standard Drop-on-Demand printheads, type Xaar 1001, whose nozzles have an aperture of about 1 μm, at a resolution of 360 DPI on the white undercoat. The thickness of the wet decoration thus obtained is between 0.5 μm and 5 μm.

A colorless protective layer is made, on the decoration and the white undercoat, by printing a composition comprising a PTFE dispersion, solvents, conventional additives and flakes of which the largest characteristic dimension is about 100 μm. Said composition has a dry matter content of about 50-55% by weight. This composition is deposited by means of a digital printing machine equipped with valve-jet technology printheads whose nozzles have an aperture of 200 μm. The thickness of the wet layer thus deposited is about 20 μm.

The disk coated on its two faces is cured at 430° C. for 10 minutes.

The thickness of the cured coating thus obtained on the second face of the disk is about 30 μm.

### Example 3

### Substrate with a Non-Stick Coating Based on Fluorocarbon Resin

The substrate is a chemically cleaned aluminum disk.

A primer composition based on a mixture of PTFE and PFA dispersions, a bonding resin (PAI), colloidal silica and carbon black dispersion, is applied by digital printing on one of the faces of the disk. Said composition has a dry matter content of about 20-25% by weight.

This digital printing is performed by means of a digital printing machine using the ink jet process, the machine being equipped with valve-jet technology printheads whose nozzles have an aperture of 100 μm. The thickness of the wet layer thus deposited is about 30 μm.

The primer layer is dried at about 100° C.

A colorless protective layer is then made on the primer layer. A colorless protective composition based on a PTFE dispersion, solvent and conventional additives is deposited by means of a digital printing machine using the ink jet process, the machine being equipped with valve-jet technology printheads whose nozzles have an aperture of 100 μm. Said composition has a dry matter content of about 50-55% by weight. The thickness of the wet layer thus deposited is about 20 μm.

The disk thus coated is cured at 430° C. for 10 minutes.

The thickness of the cured coating thus obtained is about 30 μm.

### Example 4

### Substrate with a Non-Stick Coating Based on Fluorocarbon Resin

The substrate is a chemically cleaned aluminum disk.

A primer composition based on a mixture of PTFE and PFA dispersions, a bonding resin (PAI), colloidal silica, mineral reinforcing fillers (alumina powder with particle size of 3-50 μm) and carbon black dispersion, is applied by digital printing on one of the faces of the disk. Said primer composition has a dry matter content of about 20-25% by weight.

This digital printing is performed by means of a digital printing machine using the ink jet process, the machine being equipped with valve-jet technology printheads whose nozzles have an aperture of 150 μm. The thickness of the wet layer thus deposited is about 30 μm.

The primer layer is dried at about 100° C.

A colorless protective layer is then made on the primer layer. A colorless protective composition based on a PTFE dispersion, solvent and conventional additives is deposited by means of a digital printing machine using the ink jet process, the machine being equipped with valve-jet technology printheads whose nozzles have an aperture of 100 μm. Said protective composition has a dry matter content of about 50-55% by weight. The thickness of the wet layer thus deposited is about 20 μm.

The disk thus coated is cured at 430° C. for 10 minutes.

The thickness of the cured coating thus obtained is about 30 μm.

### Example 5

### Substrate with a Non-Stick Coating Based on Fluorocarbon Resin

The substrate is a chemically cleaned aluminum disk.

A primer composition based on a mixture of PTFE and PFA dispersions, a bonding resin (PAI), colloidal silica, mineral reinforcing fillers (alumina powder with particle size of 3-50 μm) and carbon black dispersion, is applied by digital printing on one of the faces of the disk. Said primer composition has a dry matter content of about 20-25% by weight.

This digital printing is performed by means of a digital printing machine using the ink jet process, the machine being equipped with valve-jet technology printheads whose nozzles have an aperture of 150 μm. The thickness of the wet layer thus deposited is about 30 μm.

The primer layer is dried at about 100° C.

The following compositions are deposited successively by digital printing on the primer layer:
a red heat-stable decoration composition based on a PTFE dispersion and a mixture of perylene red and black pigment. Said composition has a dry matter content of about 50% by weight. This composition is printed, following a solid disk shape, by means of a digital printing machine using the ink jet process, the machine being equipped with valve-jet technology printheads whose nozzles have an aperture of 100 μm. The thickness of the wet layer thus deposited is about 5 μm;
a red thermochromic decoration composition based on a PTFE dispersion and iron oxide. Said composition has a dry matter content of about 50% by weight. This composition is printed, following a discontinuous pattern at least partially covering the red heat-stable decoration layer, by means of a digital printing machine using the ink jet process, the machine being equipped with valve-jet technology printheads whose nozzles have an aperture of 100 μm. The thickness of the wet layer thus deposited is about 5 μm;
a decoration composition in a color clearly distinct from the color of the primer layer, free of binder and comprising flakes of which the largest characteristic dimension is about 100 μm. Said composition has a dry matter content of about 20% by weight. This composition is printed, following a discontinuous pattern at least partially covering the red decoration layers, by means of a printing machine equipped with valve-jet technology printheads whose nozzles have an aperture of 200 μm. The thickness of the wet layer thus deposited is about 5 μm.

A colorless protective layer is made, on the primer layer and the decoration layers, by printing a composition comprising a PTFE dispersion, solvents, conventional additives and flakes of which the largest characteristic dimension is about 100 μm. Said composition has a dry matter content of about 50-55% by weight. This composition is deposited by means of a digital printing machine using the ink jet process, the machine being equipped with valve-jet technology printheads whose nozzles have an aperture of 200 μm. The thickness of the wet layer thus deposited is about 20 μm.

The disk thus coated is cured at 430° C. for 10 minutes. The thickness of the cured coating thus obtained is about 35 μm.

### Example 6

### Substrate with a Non-Stick Coating Based on Fluorocarbon Resin

The substrate is a chemically cleaned aluminum disk.

A composition based on a mixture of PTFE and PFA dispersions and a cobalt blue pigment dispersion having particles of about 5 μm, is applied by digital printing on one of the faces of the disk. Said primer composition has a dry matter content of about 40% by weight.

This digital printing is performed by means of a digital printing machine using the ink jet process, the machine being equipped with valve-jet technology printheads whose nozzles have an aperture of 100 μm. The thickness of the wet layer thus deposited is about 30 μm.

The disk thus coated is cured at 430° C. for 10 minutes.

The thickness of the cured coating thus obtained is about 15-20 μm.

### Example 7

### Cap with a Non-Stick Coating Presenting Improved Scratch Resistance

From an aluminum disk, a press is used to obtain a cap form.

On the bottom of the concave part of the cap, a discontinuous layer of a composition based on enamel frit slip and inorganic reinforcing fillers (alumina powder with particle size of about 25 μm) is deposited by means of a digital printing machine using the ink jet process, the machine being equipped with valve-jet technology printheads whose nozzles have an aperture of 400 μm. Said composition has a dry matter content of about 65% by weight. The thickness of the discontinuous wet layer thus obtained is about 20 μm.

The cap thus coated is cured at 560° C. for 10 minutes.

On the entire concave part of the cap, several successive PTFE-based layers are applied by spraying.

The cap thus coated is then cured at 430° C. for 10 minutes.

The thickness of the cured coating obtained is about 35 μm.

### Example 8

### Substrate with an Easy-to-Clean Lacquer Coating

The substrate is a chemically cleaned aluminum disk.

One of the faces of the substrate is coated with a layer of a composition based on silicone-polyester lacquer by means of a digital printing machine using the ink jet process, the machine being equipped with valve-jet technology printheads whose nozzles have an aperture of 100 μm. Said composition comprises the silicone-polyester lacquer, pigments and solvents, and has a dry matter content of about 50% by weight. The thickness of the wet layer thus deposited is about 20 μm.

The disk thus coated is cured at 250° C. for 10 minutes.

The thickness of the cured coating obtained is about 10 μm.

### Example 9

### Cap with an Anti-Scratch Protective Coating

From an aluminum disk, a press is used to obtain a cap form.

On the bottom of the convex part of the cap, a layer of a composition based on enamel frit slip containing stainless steel beads of about 45 μm is deposited by means of a digital printing machine using the ink jet process, the machine being equipped with valve-jet technology printheads whose nozzles have an aperture of 200 μm. These stainless steel beads are selected so as to form a protuberance and remain in direct contact with the heating surface once the coating is cured. Said composition has a dry matter content of about 70% by weight.

The thickness of the wet layer thus deposited is about 50 μm.

The cap is then cured at 560° C. for 10 minutes.

The thickness of the cured coating obtained in the end is about 30 μm with the top of the stainless steel beads visible.

### Example 10

### Cap with an Anti-Scratch Protective Coating

From an aluminum disk, a press is used to obtain a cap form.

On the bottom of the convex part of the cap, a layer of a colored composition based on silane precursors containing stainless steel beads of about 45 μm is deposited by means of a digital printing machine using the ink jet process, the machine being equipped with valve-jet technology printheads whose nozzles have an aperture of 200 μm. These stainless steel beads are selected so as to form a protuberance and remain in direct contact with the heating surface once the coating is cured. Said composition has a dry matter content of about 70% by weight.

The thickness of the wet layer thus deposited is about 50 μm.

The cap is then cured at 250° C. for 20 minutes.

The thickness of the cured coating obtained in the end is about 30 μm with the top of the stainless steel beads visible.

### Example 11

### Cap with a Sol-Gel-Based Non-Stick Coating

From an aluminum disk, a press is used to obtain a cap form.

On the entire concave face of the cap, a first layer of a colored composition based on silane precursors is applied by spraying.

On the bottom of the concave part of the cap, the following compositions are deposited successively by digital printing:
a red (mixture of perylene red and black pigment) heat-stable decoration composition free of binder. Said composition has a dry matter content of about 50% by weight. This printing is performed, following a solid disk shape, by means of a digital printing machine using the ink jet process, the machine being equipped with valve-jet technology printheads whose nozzles have an aperture of 100 μm. The thickness of the wet layer thus deposited is about 10 μm;
a red thermochromic decoration composition based on iron oxide and free of binder. Said composition has a dry matter content of about 50% by weight. This printing is performed, following a discontinuous pattern at least partially covering the red heat-stable decoration layer, by means of a digital printing machine using the ink jet process, the machine being equipped with valve-jet technology printheads whose nozzles have an aperture of 100 μm. The thickness of the wet layer thus deposited is about 10 μm;
a decoration composition in a color clearly distinct from the color of the first layer coated by spraying, free of binder and comprising flakes of which the largest characteristic dimension is about 100 μm. Said composition has a dry matter content of about 20% by weight. This printing is performed, following a discontinuous pattern at least partially covering the red decoration layers, by means of a digital printing machine using the ink jet process, the machine being equipped with valve-jet technology printheads whose nozzles have an aperture of 200 μm. The thickness of the wet layer thus deposited is about 10 μm.

On the entire concave face of the cap, a last layer of a colorless composition based on silane precursors is applied by spraying.

The cap is then cured at 250° C. for 15 minutes.

The thickness of the cured coating thus obtained is about 30 μm.

### Example 12

### Substrate with a Non-Stick Coating Based on Fluorocarbon Resin

The substrate is a mechanically brushed aluminum disk.

A primer composition based on a mixture of PTFE and FEP dispersions, a bonding resin (PAI), colloidal silica, mineral reinforcing fillers (silicon carbide with particle size of 3-50 μm) and carbon black dispersion, is applied by digital printing on one of the faces of the disk. Said primer composition has a dry matter content of about 35-40% by weight.

The digital printing is performed by means of a digital printing machine using the ink jet process, the machine being equipped with printheads of a technology as described in U.S. Pat. No. 6,460,980 and whose discharge channel has a diameter of 500 ∥m. The thickness of the wet layer thus deposited is about 30 μm.

The primer layer is dried at about 100° C.

A colorless protective layer is made, on the primer layer and the decoration layers, by printing a composition comprising a mixture of PTFE, PFA and FEP dispersions, solvents, conventional additives and flakes of which the largest characteristic dimension is about 100 μm. Said composition has a dry matter content of about 45-50% by weight.

This composition is deposited by means of a digital printing machine equipped with printheads of a technology as described in U.S. Pat. NO. 6,460,980 and whose discharge channel has a diameter of 500 μm. The thickness of the wet layer thus deposited is about 30 μm.

The disk thus coated is cured at 430° C. for 10 minutes.

The thickness of the cured coating thus obtained is about 25 μm.

### Example 13

### Substrate with a Non-Stick Coating Based on Fluorocarbon Resin

The substrate is a mechanically brushed aluminum disk.

A primer composition based on a mixture of PTFE and FEP dispersions, a bonding resin (PAI), colloidal silica, mineral reinforcing fillers (spherical alumina with particle size of 3-50 μm) and carbon black dispersion, is applied by digital printing on one of the faces of the disk. Said primer composition has a dry matter content of about 35-40% by weight.

The digital printing is performed by means of a printing machine equipped with printheads of a technology as described in the patent WO2010/146473 and whose discharge channel has a diameter of 120 μm. The thickness of the wet layer thus deposited is about 30 μm.

The primer layer is dried at about 100° C.

The following compositions are deposited successively by digital printing on the primer layer:
a red heat-stable decoration composition based on a PTFE dispersion and a mixture of perylene red and black pigment. Said composition has a dry matter content of about 50% by weight. This composition is printed, following a solid disk shape, by means of a digital printing machine using the ink jet process, the machine being equipped with valve-jet technology printheads whose nozzles have an aperture of 100 μm. The thickness of the wet layer thus deposited is about 5 μm;
a red thermochromic decoration composition based on a PTFE dispersion and iron oxide. Said composition has a dry matter content of about 50% by weight. This composition is printed, following a discontinuous pattern at least partially covering the red heat-stable decoration layer, by means of a digital printing machine using the ink jet process, the machine being equipped with valve-jet technology printheads whose nozzles have an aperture of 100 μm. The thickness of the wet layer thus deposited is about 5 μm;
a decoration composition in a color clearly distinct from the color of the primer layer, free of binder and comprising flakes of which the largest characteristic dimension is about 100 μm and spherical alumina fillers 15-50 μm in size. Said composition has a dry matter content of about 20% by weight. This composition is printed, following a discontinuous pattern at least partially covering the red decoration layers, by means of a digital printing machine using the ink jet process, the machine being equipped with valve-jet technology printheads whose nozzles have an aperture of 200 μm. The thickness of the wet layer thus deposited is about 5 μm.

A colorless protective layer is made, on the primer layer and the decoration layers, by printing a composition comprising a mixture of PTFE, PFA and FEP dispersions, solvents, conventional additives and flakes of which the largest characteristic dimension is about 100 μm. Said composition has a dry matter content of about 50-55% by weight. This composition is deposited by means of a digital printing machine using the ink jet process, the machine being equipped with valve-jet technology printheads whose nozzles have an aperture of 200 μm. The thickness of the wet layer thus deposited is about 20 μm.

The disk thus coated is cured at 430° C. for 10 minutes.

The thickness of the cured coating thus obtained is about 20 μm.

### Example 14

### Substrate with a Non-Stick Coating Based on Fluorocarbon Resin

The substrate is a mechanically brushed aluminum disk.

A composition based on a mixture of PTFE and PFA dispersions and a pigment dispersion, mixture of cobalt blue and bismuth vanadate, having particles of about 5 μm, is applied by digital printing on one of the faces of the disk. Said primer composition has a dry matter content of about 40% by weight.

The digital printing is performed by means of a digital printing machine using the ink jet process, the machine being equipped with printheads of a technology as described in U.S. Pat. No. 6,460,980 and whose discharge channel has a diameter of 500 μm. The thickness of the wet layer thus deposited is about 30 μm.

The primer layer is dried at about 100° C.

A composition in a color clearly distinct from the color of the primer layer, based on a mixture of PTFE and PFA dispersions and an iron oxide pigment dispersion, having particles of about 5 μm. Said composition has a dry matter content of about 40% by weight. This composition is printed, following a discontinuous pattern at least partially covering the first green layer, by means of a printing machine equipped with printheads as described in the patent WO2010/146473 and whose discharge channel has a diameter of 120 μm. The thickness of the wet layer thus deposited is about 20 μm.

The disk thus coated is cured at 430° C. for 10 minutes.

The cured coating thus obtained is about 20 μm in thickness and presents a red decorative pattern on a green background.

### Comparative Example 1

The substrate is a chemically cleaned aluminum disk.

A coating based on fluorocarbon resin, bonding resin and mineral reinforcing fillers is applied by screen printing in successive layers on the first face of the disk.

The whole is precured at a temperature of 350° C.

The second face of the disk receives by screen printing an undercoat of white composition based on fluorocarbon resin.

A photo-realistic decoration is made by printing a decoration composition, based on colored particulate pigments and free of binder, by ink jet using a printing system equipped with standard Drop-on-Demand printheads, type Xaar 1001, whose nozzles have an aperture of about 1 μm, at a resolution of 360 DPI on the white undercoat. The thickness of the wet decoration thus obtained is between 0.5 μm and 5 μm.

A colorless protective layer is made, on the decoration and the white undercoat, by printing a composition comprising a PTFE dispersion, solvents and conventional additives. Said composition has a dry matter content of about 10% by weight. This composition is deposited by ink jet using a digital printing system equipped with standard Drop-on-Demand printheads, type Xaar 1001, whose nozzles have an aperture of about 1 μm, at a resolution of 360 DPI. The thickness of the wet layer thus deposited is about 10 μm.

This layer is dried for 1 minute at 100° C. After drying, the thickness of the layer is about 1 μm.

To achieve a minimum final dry thickness of protective layer (that is, about 10 μm) to ensure good non-stick quality of the final coating, it is then necessary to multiply by at least 10 times the step of printing the colorless protective composition followed by a drying.

The disk coated on its two faces is cured at 430° C. for 10 minutes. The thickness of the cured coating thus obtained on the second face of the disk is about 30 μm.

The final coating thus obtained is similar to the one made in example 1, but 10 times as many printing and drying steps were necessary, which is not a reasonable industrial process.

### Comparative Example 2

The substrate is a chemically cleaned aluminum disk.

A coating based on fluorocarbon resin, bonding resin and mineral reinforcing fillers is applied by screen printing in successive layers on the first face of the disk.

The whole is precured at a temperature of 350° C.

The second face of the disk receives by screen printing an undercoat of white composition based on fluorocarbon resin.

A photo-realistic decoration is made by printing a decoration composition, based on colored particulate pigments and free of binder, by ink jet process using a printing system equipped with standard Drop-on-Demand printheads, type Xaar 1001, whose nozzles have an aperture of about 1 μm, at a resolution of 360 DPI on the white undercoat. The thickness of the wet decoration thus obtained is between 0.5 μm and 5 μm.

A colorless protective layer is made, on the decoration and the white undercoat, by printing a composition comprising a PTFE dispersion, solvents and conventional additives. Said composition has a dry matter content of about 10% by weight. This composition is deposited by ink jet process using a digital printing system equipped with standard Drop-on-Demand printheads, type Xaar 1001, whose nozzles have an aperture of about 1 μm, at a resolution of 360 DPI. The thickness of the wet layer thus deposited is about 10 μm.

To achieve a minimum final dry thickness of protective layer (that is, about 10 μm) to ensure good non-stick quality of the final coating, it is then necessary to multiply by at least 10 times the step of printing the colorless protective composition.

The thickness of the wet layer thus deposited is about 100 μm. Such a wet layer does not permit maintaining homogeneity of component distribution.

The disk coated on its two faces is cured at 430° C. for 10 minutes.

The thickness of the cured coating thus obtained on the second face of the disk is about 30 μm.

The final coating thus obtained has a non-homogeneous protective layer, the added thicknesses formed are very yellow and cracked and there are areas of very low thicknesses where the non-stick quality is insufficient.

1. A process for producing a small heating household equipment article comprising a substrate with at least two opposite faces, the process comprising:
providing said substrate; and
obtaining a heat-stable coating on said substrate, said obtaining step comprising:
depositing on at least one of the two opposite faces of said substrate at least one layer of a composition comprising at least one binder; and
curing said coated substrate,
wherein the composition comprising at least one binder has a dry matter content greater than or equal to 15% by weight, and
wherein said deposition is carried out through digital printing via at least one nozzle having an aperture greater than or equal to 80 μm in size.

2. The process according to claim 1, wherein said composition has a dry matter content greater than or equal to 20% by weight.

3. The process according to claim 1, wherein the binder comprises at least one of a bonding resin, a fluorocarbon resin, a sol-gel composition, an enamel frit slip, a lacquer, and a condensed tannin.

4. The process according to claim 1, wherein the substrate is chosen from among metallic material substrates, glass substrates, ceramic substrates, terracotta substrates, and plastic substrates.

5. The process according to claim 1, wherein the small heating household equipment article is a culinary article or a small household appliance article.

6. The process according to claim 1, wherein the size of the nozzle aperture is less than or equal to 1.5 mm.

7. The process according to claim 1, wherein the composition further comprises functional fillers.

8. The process according to claim 1, wherein the a thickness of the layer printed by digital printing is greater than 0.1 μm and less than or equal to 1000 μm.

9. The process according to claim , wherein a thickness of the heat-stable coating, after curing of the coated substrate, is greater than 0.1 μm and less than or equal to 1000 μm.

10. The process according to claim 1, wherein the heat-stable coating further comprises at least one decoration and/or at least one other layer.

11. The process according to claim 1, wherein said deposition is carried out through digital printing using the ink jet process.

12. The process according to claim 10, wherein the at least one other layer is an undercoat, a primer layer or a protective layer.
